(19) United States
(12) Patent Application Publication
(10) Pub. No.: US 2007/0085769 A1
(43) Pub. Date: Apr. 19, 2007

(54) Energy recovery circuit for display panel and driving apparatus with the same

(75) Inventor: Kwang-Ho Jin, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI, Co., Ltd., Suwon-si (KR)

(21) Appl. No.: 11/529,360

(22) Filed: Sep. 29, 2006

(30) Foreign Application Priority Data
Oct. 17, 2005 (KR) 2005-97520

(51) Int. Cl. G09G 3/28

(52) U.S. Cl. 345/66

(57) ABSTRACT

An energy recovery circuit for a display panel, which can normally operate at its initial operation stage, and a driving apparatus with the same includes, an energy storage unit, an energy recovery switching unit, an inductor, and a charge power supply unit. The energy storage unit recovers an electric charge from the panel capacitor and charging the panel capacitor with electric charge. The energy recovery switching unit controls charging of the electric charge to the panel capacitor from the energy storage unit and recovery of the electric charge from the panel capacitor to the energy storage unit. The inductor has one end connected to the energy recovery switching unit and the other end connected to the panel capacitor. The charge power supply unit supplies power to the energy storage unit.

### CROSS-REFERENCE TO RELATED APPLICATION

This application claims the benefit of Korean Application No. 2005-97520, filed on Oct. 17, 2005, in the Korean Intellectual Property Office, the disclosure of which is incorporated herein by reference.

### BACKGROUND OF THE INVENTION

1. Field of the Invention

Aspects of the present invention relate to an energy recovery circuit for a display panel and a driving apparatus with the same, and more particularly, to an energy recovery circuit for a display panel, which can normally operate at its initial operation stage, and a driving apparatus with the same.

2. Description of the Related Art

Plasma display panels (PDPs) can be easily manufactured in large sizes and are widely used as flat-panel displays. The PDP displays an image using a discharge phenomenon. Generally, the PDPs can be classified into a direct current (DC) PDP and an alternating current (AC) PDP according to the type of driving voltage. Since the DC PDP is disadvantageous in its long discharge delay, the AC PDP is more actively being developed.

A typical example of the AC PDP is a three-electrode surface discharge AC PDP that is driven by an AC voltage applied through three electrodes. The three-electrode surface discharge AC PDP includes a plurality of stacked plates. The three-electrode surface discharge AC PDP is more advantageous over a cathode ray tube (CRT) in terms of space efficiency because the three-electrode surface discharge AC PDP is thinner and lighter than the CRT while providing a wider screen than that of the CRT.

A three-electrode surface discharge AC PDP and an apparatus and method for driving the same are disclosed in U.S. Pat. No. 6,744,218 entitled “Method of driving a plasma display panel in which the width of display sustain pulse varies” and assigned to the assignee of this Application, which is incorporated herein by reference.

In order to drive the AC PDP, an AC voltage higher than a discharge start voltage to cause a discharge in a gas must be continuously applied alternately across sustain electrodes in a discharge cell. A dielectric is coated on the sustain electrodes. Consequently, a panel capacitor with a constant capacitance is formed between X and Y electrodes (i.e., the sustain electrodes).

Accordingly, a charge/discharge operation of the panel capacitor must be performed in order to alternately apply negative (−) and positive (+) high voltages (i.e., the high AC voltage) across the sustain electrodes. Undesirably, the panel capacitor consumes a considerable amount of energy during its charge/discharge operation which is wasted. Therefore, as the panel capacitor increases in size in proportion to the size of the PDP, its power consumption increases greatly due to the wasted energy.

To solve this problem, U.S. Pat. No. 4,866,349 discloses an energy recovery circuit used in a driving device for a plasma display panel to reduce energy loss generated during a charge/discharge operation of a panel capacitor.

However, the above energy recovery circuit cannot normally operate at its initial operation stage, and thus a hard switching operation occurs to damage a driving board.

### SUMMARY OF THE INVENTION

Aspects of the present invention provide an energy recovery circuit for a display panel, which can normally operate at its initial operation stage, and a driving apparatus with the same.

According to an aspect of the present invention, there is provided an energy recovery circuit for a display panel where a panel capacitor is formed between at least two electrode lines among two or more electrode lines, the energy recovery circuit recovering discharge energy from the panel capacitor and charging the panel capacitor with charge energy according to a charge/discharge operation of the panel capacitor, the energy recovery circuit including: an energy storage unit recovering an electric charge from the panel capacitor and charging the panel capacitor with the electric charge; an energy recovery switching unit controlling charging of the electric charge to the panel capacitor from the energy storage unit and recovery of the electric charge from the panel capacitor to the energy storage unit; an inductor having one end connected to the energy recovery switching unit and the other end connected to the panel capacitor; and a charge power supply unit supplying power to the energy storage unit.

The energy storage unit may include a capacitor for recovering discharge energy from the panel capacitor and charging the panel capacitor with charge energy according to a charge/discharge operation of the panel capacitor.

The energy recovery switching unit may include: a first control switch having one end connected to the energy storage unit and the other end connected to the inductor; a second control switch connected in parallel to the first control switch; a first diode connected between the first control switch and the inductor such that a current flows from the first control switch to the inductor; and a second diode connected between the second control switch and the inductor such that a current flows from the inductor to the second control switch.

The inductor may resonate during the charge/discharge operation of the panel capacitor.

The charge power supply unit may include two or more impedance elements serially connected between a power source and a ground terminal, and may supply a voltage to the energy storage unit by a voltage division operation of the impedance elements.

The impedance elements may be resistors.

The impedance elements may be capacitors.

According to another aspect of the present invention, there is provided a driving apparatus for a display panel where a panel capacitor is formed between at least two electrode lines among two or more electrode lines, the driving apparatus recovering discharge energy from the panel capacitor and charging the panel capacitor with charge energy according to a charge/discharge operation of the panel capacitor, the driving apparatus includes: a sustain driving circuit connected to a power supply terminal and switched according to an external control signal to supply a sustain voltage to the panel capacitor so that the display panel performs a sustain operation, and configured to periodically discharge the charge energy; and an energy recovery circuit recovering an electric charge from the panel capacitor and charging the panel capacitor with the electric charge, the energy recovery circuit being able to charge the panel capacitor with the electric charge even at an initial operation stage of the panel capacitor.

The energy recovery circuit may include: an energy storage unit recovering the electric charge from the panel capacitor and charging the panel capacitor with the electric charge; an energy recovery switching unit controlling charging of the electric charge to the panel capacitor from the energy storage unit and recovery of the electric charge from the panel capacitor to the energy storage unit; an inductor having one end connected to the energy recovery switching unit and the other end connected to the panel capacitor; and a charge power supply unit supplying power to the energy storage unit.

According to an aspect of the present invention, the energy recover circuit can operate even at its initial operation stage.

According to an aspect of the present invention, an energy recovery circuit for a display panel to supply and recover energy from a panel capacitor, includes: a bidirectional switch connected to the panel capacitor to direct flow of charge to and from the panel capacitor; a storage unit connected to the bidirectional switch to supply and to store the charge to/from the panel capacitor; and a voltage supply connected to the storage unit and the bidirectional switch to supply voltage to the storage unit or the panel capacitor.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a perspective view illustrating the structure of a plasma display panel (PDP) driven by a driving apparatus according to an aspect of the present invention;

FIG. 2 is a diagram illustrating the arrangement of electrodes in the PDP of FIG. 1;

FIG. 3 is a block diagram of a driving apparatus for the PDP illustrated in FIG. 1;

FIG. 4 is a timing diagram of driving signals outputted from respective drivers of FIG. 3 according to an aspect of the present invention;

FIG. 5 is a circuit diagram of an energy recovery circuit according to an aspect of the present invention;

FIG. 6 is a circuit diagram of an energy recovery circuit according to another aspect of the present invention;

FIG. 7 is a circuit diagram of an X driver having the energy recovery circuit of FIG. 5, according to an aspect of a driving apparatus for a PDP of the present invention; and

FIG. 8 is a circuit diagram of a Y driver having the energy recovery circuit of FIG. 6, according to an aspect of a driving apparatus for a PDP of the present invention.

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

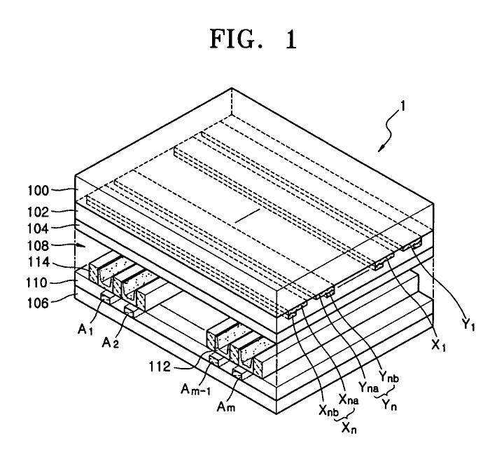

FIG. 1 is a perspective view illustrating the structure of a plasma display panel (PDP) driven by a driving apparatus according to an aspect of the present invention.

Referring to FIG. 1, the PDP includes a first substrate 100 and a second substrate 106. Disposed between the first and second substrates 100 and 106 are electrodes A₁, . . . , Aₘ, first and second dielectric layers 102 and 110, Y electrodes Y₁, . . . , Yₙ, X electrodes X₁,. . . , Xₙ, a phosphor layer 112, barrier ribs 114, and a protective layer (e.g., a magnesium oxide (MgO) layer) 104.

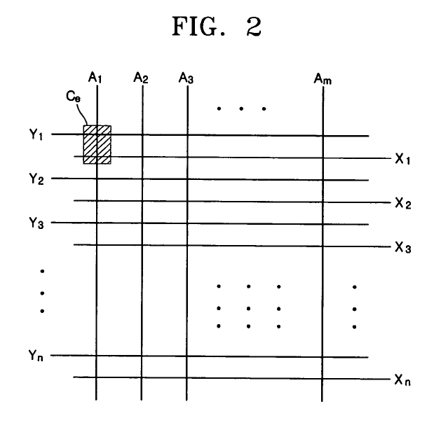

The A electrodes A₁, . . . , Aₘ are formed on the second substrate 106 in a predetermined pattern. The second dielectric layer 110 is formed to cover the A electrodes A₁, . . . , Aₘ. The barrier ribs 114 are formed on the second dielectric layer 110 in parallel to the A electrodes A₁, . . . , Aₘ. The barrier ribs 114 define discharge regions of discharge cells (shown in FIG. 2), and prevent optical interference between the discharge cells. The phosphor layer 112 is formed between the barriers on the second dielectric layer 110, and includes red, green and blue phosphor layers that are arranged sequentially. The phosphor layer 112 may also be formed of the sides of the barrier ribs 114.

The X electrodes X₁, . . . , Xₙ and the Y electrodes Y₁, . . . , Yₙ are formed on the first substrate 100 in a predetermined pattern and are perpendicular to the A electrodes A₁, . . . , Aₘ. Each of the X electrodes X₁, . . . , Xₙ may include a transparent conductive electrode Xₙₐ and a metal electrode X_{nb} connected to the transparent conductivity electrode Xₙₐ to enhance conductivity. Likewise, each of the Y electrodes Y₁, . . . , Yₙ may include a transparent conductive electrode Yₙₐ and a metal electrode Y_{nb} connected to the transparent conductivity electrode Yₙₐ to enhance conductivity. The first dielectric layer 102 is formed on the first substrate 100 to cover the X electrodes X₁, . . . , Xₙ and the Y electrodes Y₁, . . . , Yₙ. The protective layer 104 is formed to cover the first dielectric layer 102 and protect the panel from a strong electric field. A discharge space is formed between the first and second substrates 100 and 106, and is hermetically sealed and filled with plasma forming gas. Examples of such gas include noble gases such as Neon and Xenon.

It should be noted that the FIG. 1 aspect of the PDP driven by the driving apparatus should be considered in a descriptive sense only and not for the purposes of limitation.

FIG. 2 is a diagram illustrating the arrangement of the electrodes in the PDP of FIG. 1.

Referring to FIG. 2, the Y electrodes Y₁, . . . , Yₙ and the X electrodes X₁, . . . , Xₙ are disposed parallel to each other. The A electrodes A₁, . . . , Aₘ are disposed perpendicularly to intersect the Y electrodes Y₁, . . . , Yₙ and the X electrodes X₁, . . . , Xₙ, and the resulting intersected portion partitions define discharge cells such as Ce.

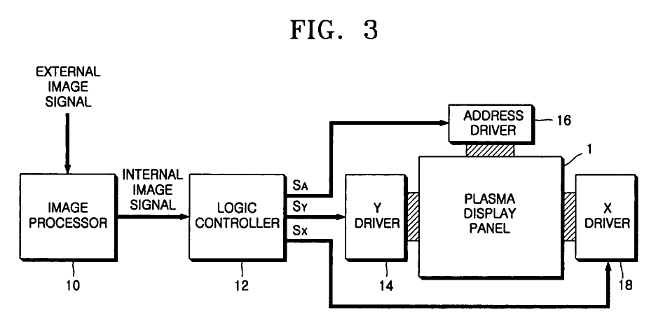

FIG. 3 is a block diagram of a driving apparatus for the PDP illustrated in FIG. 1.

Referring to FIG. 3, the driving apparatus includes an image processor 10, a logic controller 12, a Y driver 14, an address driver 16, an X driver 18, and a plasma display panel 1. The image processor 10 converts an external image signal into an internal image signal. The logic controller 12 receives the internal image signal to output an address driving control signal S_{A}, a Y driving control signal S_{Y}, and an X driving control signal S_{X}. The Y driver 14, the address driver 16, and the X driver 18 receive the address driving control signal S_{A}, the Y driving control signal S_{Y}, and the X driving control signal S_{X}, respectively, to output driving signals to Y, A and X electrodes of the plasma display panel 1.

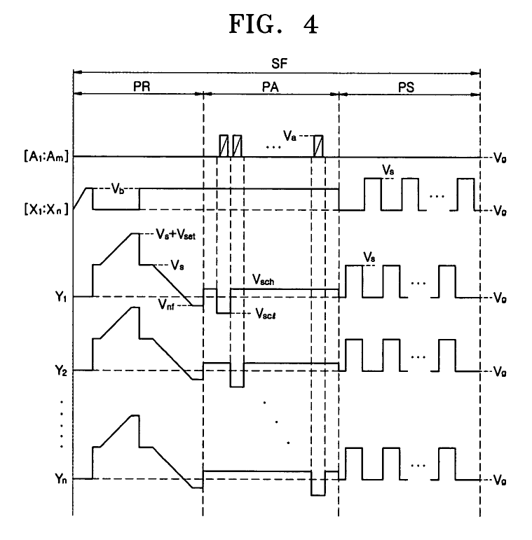

FIG. 4 is a timing diagram of the driving signals outputted from the respective drivers of FIG. 3 according to an aspect of the present invention.

Referring to FIG. 4, a unit frame (not shown) for driving the plasma display panel 1 is divided into a plurality of sub-fields (SF), and each sub-field (SF) is divided into a reset period PR, an address period PA, and a sustain period PS.

During the reset period PR, a reset pulse including a rising pulse and a falling pulse is applied to the Y electrodes Y₁, . . . , Yₙ, and a second voltage (a bias voltage) is applied to the X electrodes X₁, . . . , Xₙ from the time of application of the falling pulse, causing a reset discharge in the discharge cell. The entire discharge cell is initialized by the reset discharge. The rising pulse rises from a sustain discharge voltage Vs by a rising voltage Vₛₑₜ to reach the highest rising voltage (Vₛₑₜ+Vs), and the falling pulse falls from the sustain discharge voltage Vs to the lowest falling voltage V_{nf}.

During the address period PA, scan pulses are sequentially applied to the Y electrodes Y₁, . . . , Yₙ, and display data signals are applied to the A electrodes A₁, . . . , Aₘ in accordance with the scan pulses, causing an address discharge. A discharge cell where a sustain discharge will occur during the sustain period is selected by the address discharge. The scan pulses sequentially fall from a scan high voltage Vsch to a scan low voltage Vscl. The display data signal has a positive address voltage Va in accordance with application of the scan low voltage Vscl of the scan pulse.

During the sustain period PS, sustain pulses are alternately applied to the X electrodes X₁, . . . , Xₙ and the Y electrodes Y₁, . . . , Yₙ, causing a sustain discharge. Brightness is expressed by the sustain discharge according to a gradation weight assigned to each sub-field. The sustain pulses alternate between the sustain discharge voltage Vs and a ground voltage Vg.

It should be noted that the driving signals illustrated in FIG. 4 should be considered in a descriptive sense only and not for the purposes of limitation.

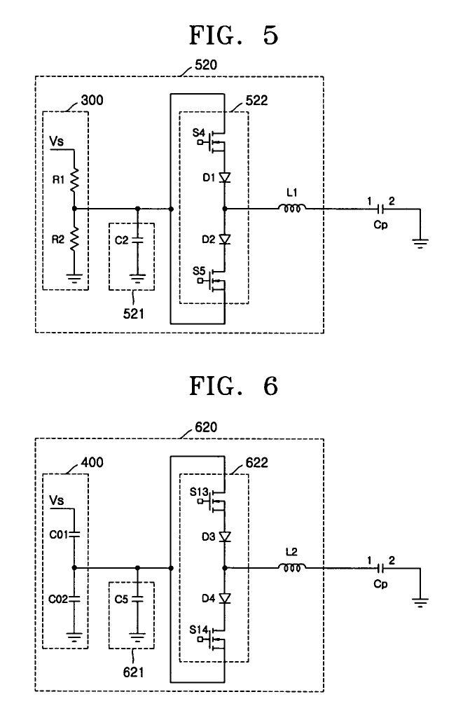

FIG. 5 is a circuit diagram of an energy recovery circuit according to an aspect of the present invention, and FIG. 6 is a circuit diagram of an energy recovery circuit according to another aspect of the present invention.

Referring to FIGS. 5 and 6, with respect to a display panel where a panel capacitor Cp is formed between at least two electrode lines (e.g., X and Y electrode lines), energy recovery circuits 520 and 620 recover energy from the panel capacitor Cp or charge the panel capacitor Cp with energy according to the charge/discharge (that is the charge and/or discharge) operation of the panel capacitor Cp. The energy recovery circuit 520 includes an energy storage unit 521, an energy recovery switching unit 522, an inductor L1, and a charge power supply unit 300. Likewise, the energy recovery circuit 620 includes an energy storage unit 621, an energy recovery switching unit 622, an inductor L2, and a charge power supply unit 400.

For brevity, the descriptions of each of the energy recovery circuits 520 and 620 are combined below. The energy storage unit 521 (621) recovers an electric charge from the panel capacitor Cp and charges the panel capacitor Cp with the electric charge. The energy recovery switching unit 522 (622) controls charging of the panel capacitor Cp with the electric charge by the energy storage unit 521 (621) and recovery of the electric charge from the panel capacitor Cp by the energy storage unit 521 (621). The inductor L1 (L2) has one end connected to the energy recovery switching unit 522 (622) and the other end connected to the panel capacitor Cp. The charge power supply unit 300 (400) supplies power to the energy storage unit 521 (621).

The energy storage unit 521 (621) recovers the electric charge from the panel capacitor Cp and charges the panel capacitor Cp with the electric charge. For this purpose, the energy storage unit 521 (621) may include a capacitor C2 (C5) for charging the panel capacitor Cp with the electric charge and recovering the electric charge from the panel capacitor Cp.

The energy recovery switching unit 522 (622) controls charging of the panel capacitor Cp with the electric charge by the energy storage unit 521 (621) and recovery of the electric charge from the panel capacitor Cp by the energy storage unit 521 (621). For this purpose, the energy recovery switching unit 522 (622) may include a first control switch S4 (S3), a second control switch S5 (S14), a first diode D1 (D3), and a second diode D2 (D4).

The first control switch S4 (S13) has one end connected to the energy storage unit 521 (621) and the other end connected to the inductor L1 (L2). The second control switch S5 (S14) is connected in parallel to the first control switch S4 (S13). The first diode D1 (D3) is connected between the first control switch S4 (S13) and the inductor L1 (L2) so that a current can flow from the first control switch S4 (S13) to the inductor L1 (L2). The second diode D2 (D4) is connected between the second control switch S5 (S14) and the inductor L1 (L2) so that a current can flow from the inductor L1 (L2) to the second control switch S5 (S14).

The inductor L1 (L2) has one end connected to the energy recovery switching unit 522 (622) and the other end connected to the panel capacitor Cp. The inductor L1 (L2) may be constructed to resonate during the charge/discharge operation of the panel capacitor Cp.

The charge power supply unit 300 (400) supplies power to the energy storage unit 521 (621), and can operate to charge the panel capacitor Cp with the electric charge even at an initial operation stage of the panel capacitor Cp before the panel capacitor Cp is initially charged. For this purpose, the charge power supply unit 300 (400) includes two or more impedance elements R1 and R2 (C01 and C02) serially connected between a power source Vs and a ground terminal, and supplies a voltage to the energy storage unit 521(621) by a voltage division operation of the impedance elements R1 and R2 (C01 and C02).

In aspects of the present invention, the energy storage unit 521(621) may be supplied with a voltage of Vs/2 corresponding to ½ of the power voltage Vs that is supplied to the panel capacitor Cp for the light emission of the PDP. For this purpose, the impedance elements R1 and R2 (C01 and C02) may have the same impedance.

The impedance elements, as discussed above, may be resistors as R1 and R2 illustrated in FIG. 5, or capacitors C01 and C02 as illustrated in FIG. 6. The resistors R1 and R2 may have the same resistance in order to supply the voltage of Vs/2 to the energy storage unit 521, for example. Likewise, the capacitors C01 and C02 may have the same capacitance in order to supply the voltage of Vs/2 to the energy storage unit 621, for example. In aspects of the present invention, a voltage other than Vs/2 may be supplied to the energy storage units 521 and 621, and the respective resistors and capacitors may be modified accordingly. The voltage, such as Vs/2, may also be supplied to the panel capacitor Cp, for example, for a light emitting operation of the display panel.

In various aspects of the present invention, with respect to the display panel where the panel capacitor Cp is formed between at least two electrode lines among two or more electrode lines, the driving apparatus for the PDP recovers discharge energy from the panel capacitor Cp or charges the panel capacitor Cp with charge energy according to the charge/discharge operation of the panel capacitor Cp. For this purpose, the driving apparatus includes: a sustain driving unit connected to a power supply terminal, switched according to an external control signal to supply a sustain voltage to the panel capacitor such that the display panel performs a sustain operation, and configured to periodically discharge the charge energy; and an energy recovery unit recovering the electric charge from the panel capacitor and charging the panel capacitor with the electric charge. The energy recovery unit can charge the panel capacitor with the electric charge even at an initial operation stage of the panel capacitor Cp before the panel capacitor Cp is initially charged.

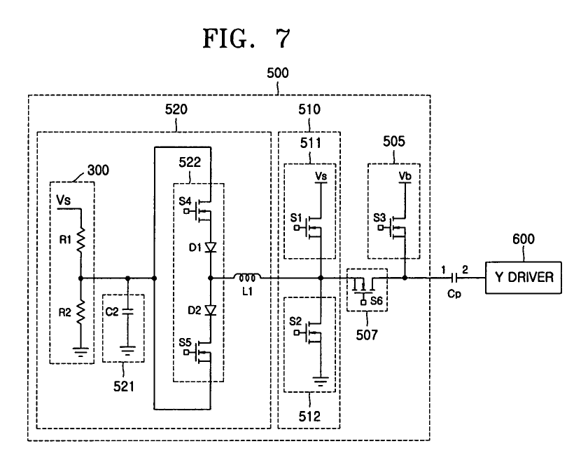

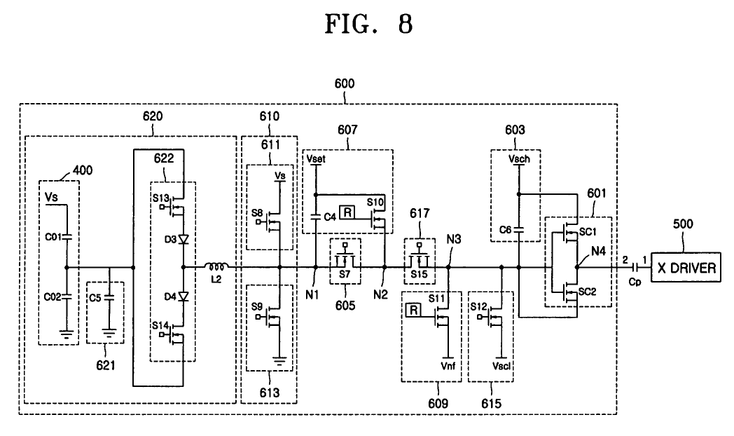

The sustain driving unit and the energy recovery unit may constitute an X driver 500 (a Y driver 600) of FIG. 7 (FIG. 8). Although FIG. 7 (FIG. 8) illustrates the X driver 500 (the Y driver 600) including an energy recovery circuit (ERC), the present invention is not limited to this structure but may be applied to various other aspects including an aspect in which the address driver 16 of FIG. 3 includes an ERC.

In addition, the X driver 500 of FIG. 7 may include the energy recovery circuit 620 of FIG. 6, instead of the energy recovery circuit 520 of FIG. 5. Similarly, the Y driver 600 of FIG. 8 may include the energy recovery circuit 520 of FIG. 5, instead of the energy recovery circuit 620 of FIG. 6.

FIG. 7 is a circuit diagram of an X driver 500 including the energy recovery circuit 520 of FIG. 5, according to an aspect of a driving apparatus for a PDP of the present invention.

Referring to FIG. 7, the driving apparatus (e.g., the X driver 500) includes: a sustain pulse applying circuit 510 including a first voltage applying unit 511 outputting a first voltage Vs and a ground voltage applying unit 512 outputting a ground voltage Vg, in order to output driving signals to X electrodes (i.e., a first terminal of a panel capacitor Cp); a second voltage applying unit 505 outputting a second voltage Vb; an energy recovery circuit 520 charging the panel capacitor Cp with the electric charge or recovering the electric charge from the panel capacitor Cp; and a switching unit 507. Either the energy recovery circuit 520 of FIG. 5 or the energy recovery circuit 620 of FIG. 6 may be used in the driving apparatus of FIG. 7.

The first voltage applying unit 511 includes a first switching element S1 having one end connected to the first voltage source (Vs) and the other end connected to the switching unit 507. The ground voltage applying unit 512 includes a second switching element S2 having one end connected to the ground (Vg) and the other end connected to the switching unit 507. The sustain pulse applying circuit 510 includes the first voltage applying unit 511 and the ground voltage applying unit 512, and the first and second switching elements S1 and S2 that are alternately turned on to generate a sustain pulse.

The second voltage applying unit 505 includes a third switching element S3 that has one end connected to the second voltage source (Vb) and the other end connected to the X electrodes of the panel (i.e., the first terminal of the panel capacitor Cp) and the switching unit 507. The third switching element S3 is turned on to output the second voltage Vb to the X electrodes.

The energy recovery circuit 520 includes: an energy storage unit 521 recovering an electric charge from the panel capacitor Cp and charging the panel capacitor Cp with the electric charge; an energy recovery switching unit 522 controlling charging of the panel capacitor Cp with the electric charge by the energy storage unit 521 and recovery of the electric charge from the panel capacitor Cp by the energy storage unit 521; and an inductor L1 having one end connected to the energy recovery switching unit 522 and the other end connected to the X electrodes (the first terminal of the panel capacitor Cp) through the switching unit 507.

The energy storage unit 521 may include a second capacitor C2 for storing the electric charge recovered from the panel capacitor Cp. The energy recovery switching unit 522 may include: fourth and fifth switching elements S4 and S5 having one end connected to the energy storage unit 521 and the other end connected to the inductor L1; and first and second diodes D1 and D2 connected between the fourth and fifth switching elements S4 and S5 in an opposite direction.

An operation of the energy recovery circuit 520 will now be described in detail. When the fifth switching element S5 of the energy recovery switching unit 522 is turned on, the second capacitor C2 is charged with the electric charge received from the panel capacitor Cp through the inductor L1, the second diode D2 and the fifth switching element S5. On the contrary, when the fourth switching element S4 of the energy recovery switching unit 522 is turned on, the panel capacitor Cp is charged with the electric charge received from the second capacitor C2 through the fourth switching element S4, the first diode D1 and the inductor L1.

The switching unit 507 includes a sixth switching element S6 having one end connected to the sustain pulse applying circuit 510 and the other end connected to the second voltage applying unit 505 and the X electrodes (i.e., the first terminal of the panel capacitor Cp). The switching unit 507 performs a switching operation for applying a sustain pulse from the sustain pulse applying circuit 510 to the X electrodes, and also performs a switching operation for preventing the second voltage Vb of the second voltage applying unit 505 from flowing toward the sustain pulse applying circuit 510. That is, the sixth switching element S6 is turned on to supply the sustain pulse to the X electrodes, and is turned off to prevent the second voltage Vb from flowing toward the sustain pulse applying circuit 510.

FIG. 8 is a circuit diagram of a Y driver including the energy recovery device 620 of FIG. 6, according to another aspect of a driving apparatus for a PDP of the present invention.

Referring to FIG. 8, the driving apparatus includes: a sustain pulse applying circuit 610 including a first voltage applying unit 611 outputting a first voltage Vs to a first node N1 and a ground voltage applying unit 613 outputting a ground voltage Vg to the first node N1, in order to output driving signals to Y electrodes (i.e., a second terminal of a panel capacitor Cp); a first switching unit 605 including a seventh switching element S7 having one end connected to the first node N1 and the other end connected to a second node N2; a second switching unit 617 including a fifteenth switching element S15 having one end connected to the second node N2 and the other end connected to a third node N3; a third voltage applying unit 607 connected between the first node N1 and the second node N2 to gradually increase the first voltage Vs by a third voltage Vset to output the increased voltage to the second node N2; a fourth voltage applying unit 609 connected to the third node N3 and to gradually decrease the first voltage Vs down to a fourth voltage Vnf to output the decreased voltage to the third node N3; a scan switching unit 601 including first and second scan switching elements SC1 and SC2 that are serially connected to each other, and a fourth node N4 located between the first and second scan switching elements SC1 and SC2 and connected to the Y electrodes; a fifth voltage applying unit 603 including a fifth voltage (Vsch) source and connected to the first scan switching element SC1 to output the fifth voltage Vsch to the first scan switching element SC1; a sixth voltage applying unit 615 connected to the second node N3 and the second scan switching element SC2 to output a sixth voltage Vscl; and an energy recovery circuit 620 charging the panel capacitor Cp with the electric charge or recovering the electric charge from the panel capacitor Cp. Either the energy recovery circuit 520 of FIG. 5 or the energy recovery circuit 620 of FIG. 6 may be used in the driving apparatus of FIG. 8.

The first voltage applying unit 611 includes an eighth switching element S8 having one end connected to the first voltage source (Vs) and the other end connected to the first node N1. The ground voltage applying unit 613 includes a ninth switching element S9 having one end connected to the ground (Vg) and the other end connected to the first node N1. The sustain pulse applying circuit 610 includes the first voltage applying unit 611 and the ground voltage applying unit 613, and the eight and ninth switching elements S8 and S9 are alternately turned on to generate a sustain pulse.

The third voltage applying unit 607 includes a fourth capacitor C4 having one end connected to the first node N1 and the other end connected to a third voltage source Vset and a tenth switching element S10 connected between the third voltage source Vset and the second node N2. When the seventh switching element S7 of the first switching unit 605 is turned off, the fifteenth switching element S15 of the second switching unit 617 is turned on, and the eighth switching element S8 of the first voltage applying unit 611 and the tenth switching element S10 of the third voltage applying unit 607 are turned on, the first voltage Vs gradually increases by the third voltage Vset and the highest rising voltage (Vset+Vs) is outputted to the third node N3.

The fourth voltage applying unit 609 includes an eleventh switching element S11 having one end connected to the third node N3 and the other end connected to a fourth voltage source Vnf. When the eighth switching element S8 of the first voltage applying unit 611, the seventh switching element S7 of the first switching unit 605, the fifteenth switching element S1 5 of the second switching unit 617, and the eleventh switching element S11 of the fourth voltage applying unit 609 are turned on, the first voltage Vs gradually decreases to the fourth voltage Vnf and the gradually-decreased voltage is outputted to the third node N3.

The sixth voltage applying unit 615 includes a twelfth switching element S12 connected between the third node N3 and a sixth voltage source Vscl. The twelfth switching element S12 is turned on to output the sixth voltage Vscl to the third node N3.

When the first scan switching element SC1 of the scan switching unit 601 is turned on and the second scan switching element SC2 is turned off, the fifth voltage Vsch is outputted through the fourth node N4 to the Y electrodes (the second terminal of the panel capacitor Cp). On the contrary, when the first scan switching element SC1 is turned off and the second scan switching element SC2 is turned on, the voltages outputted to the third node N3 (i.e., the first voltage Vs, the ground voltage Vg, the highest rising voltage (Vs+Vset), the fourth voltage Vnf, and the sixth voltage Vscl) are outputted through the fourth node N4 to the Y electrodes.

The energy recovery circuit 620 includes: an energy storage unit 621 recovering the electric charge from the panel capacitor Cp and charging the panel capacitor Cp with the electric charge; an energy recovery switching unit 622 controlling charging of the panel capacitor Cp with the electric charge by the energy storage unit 621 and recovery of the electric charge from the panel capacitor Cp by the energy storage unit 621; and an inductor L2 having one end connected to the energy recovery switching unit 622 and the other end connected to the first node N1.

The energy storage unit 621 may include a fifth capacitor C5 for storing the electric charge recovered from the panel capacitor Cp. The energy recovery switching unit 622 may include: thirteenth and fourteenth switching elements S13 and S14 each having one end connected to the energy storage unit 621 and the other end connected to the inductor L2; and third and fourth diodes D3 and D4 connected between the thirteenth and fourteenth switching elements S13 and S14 in an opposite direction.

For describing an operation of the energy recovery circuit 620, it is assumed that the seventh switching element S7 of the first switching unit 605 and the second scan switching element SC2 of the scan switching unit 601 are in a turned-on state. When the fourteenth switching element S14 of the energy recovery switching unit 622 is turned on, the fifth capacitor C5 is charged with the electric charge received from the panel capacitor Cp through the inductor L2, the fourth diode D4 and the fourteenth switching element S14. On the contrary, when the thirteenth switching element S13 of the energy recovery switching unit 622 is turned on, the panel capacitor Cp is charged with the electric charge received from the fifth capacitor C5 through the thirteenth switching element S13, the third diode D3 and the inductor L2.

As described above, the present energy recovery circuit for the display panel can normally operate at its initial operation stage. That is, an initial voltage is supplied to the storage unit.

Accordingly, the damage of the driving board due to the hard switching operation can be reduced.

Also, the energy recovery circuit can recover the wasted energy from the panel capacitor and charge the panel capacitor with the recovered wasted energy, thereby reducing the energy loss.

Although a few aspects of the present invention have been shown and described, it would be appreciated by those skilled in the art that changes may be made in this aspect without departing from the principles and spirit of the invention, the scope of which is defined in the claims and their equivalents.

What is claimed is:

1. An energy recovery circuit for a display panel where a panel capacitor is formed between at least two electrode lines among two or more electrode lines, the energy recovery circuit recovering discharge energy from the panel capacitor and charging the panel capacitor with charge energy according to a charge/discharge operation of the panel capacitor, the energy recovery circuit comprising:
an energy storage unit recovering an electric charge from the panel capacitor and charging the panel capacitor with the electric charge;
an energy recovery switching unit controlling charging of the electric charge to the panel capacitor from the energy storage unit and recovery of the electric charge from the panel capacitor to the energy storage unit;
an inductor having one end connected to the energy recovery switching unit and the other end connected to the panel capacitor; and
a charge power supply unit supplying power to the energy storage unit.

2. The energy recovery circuit of claim 1, wherein the energy storage unit comprises a capacitor to recover discharge energy from the panel capacitor and charging the panel capacitor with charge energy according to a charge/discharge operation of the panel capacitor.

3. The energy recovery circuit of claim 1, wherein the energy recovery switching unit comprises:
a first control switch having one end connected to the energy storage unit and the other end connected to the inductor;
a second control switch connected in parallel to the first control switch;
a first diode connected between the first control switch and the inductor such that a current flows from the first control switch to the inductor; and
a second diode connected between the second control switch and the inductor such that a current flows from the inductor to the second control switch.

4. The energy recovery circuit of claim 1, wherein the inductor resonates during the charge/discharge operation of the panel capacitor.

5. The energy recovery circuit of claim 1, wherein the charge power supply unit comprises two or more impedance elements serially connected between a power source and a ground terminal, and supplies a voltage to the energy storage unit by a voltage division operation of the impedance elements.

6. The energy recovery circuit of claim 5, wherein the charge power supply unit applies, to the energy storage unit, a voltage corresponding to 1/2 of a power source voltage supplied to the panel capacitor for a light emitting operation of the display panel.

7. The energy recovery circuit of claim 5, wherein the impedance elements are resistors.

8. The energy recovery circuit of claim 5, wherein the impedance elements are capacitors.

9. A driving apparatus for a display panel where a panel capacitor is formed between at least two electrode lines among two or more electrode lines, the driving apparatus recovering discharge energy from the panel capacitor and charging the panel capacitor with charge energy according to a charge/discharge operation of the panel capacitor, the driving apparatus comprising:
a sustain driving circuit connected to a power supply terminal and switched according to an external control signal to supply a sustain voltage to the panel capacitor so that the display panel performs a sustain operation, and configured to periodically discharge the charge energy; and
an energy recovery circuit recovering an electric charge from the panel capacitor and charging the panel capacitor with the electric charge, the energy recovery circuit being able to charge the panel capacitor with the electric charge even at an initial operation stage of the panel capacitor.

10. The driving apparatus of claim 9, wherein the energy recovery circuit comprises:
an energy storage unit recovering the electric charge from the panel capacitor and charging the panel capacitor with the electric charge;
an energy recovery switching unit controlling charging of the electric charge to the panel capacitor from the energy storage unit and recovery of the electric charge from the panel capacitor to the energy storage unit;
an inductor having one end connected to the energy recovery switching unit and the other end connected to the panel capacitor; and
a charge power supply unit supplying power to the energy storage unit.

11. The driving apparatus of claim 10, wherein the energy storage unit comprises a capacitor to recover discharge energy from the panel capacitor and charging the panel capacitor with charge energy according to a charge/discharge operation of the panel capacitor.

12. The driving apparatus of claim 10, wherein the energy recovery switching unit comprises:
a first control switch having one end connected to the energy storage unit and the other end connected to the inductor;
a second control switch connected in parallel to the first control switch;
a first diode connected between the first control switch and the inductor such that a current flows from the first control switch to the inductor; and
a second diode connected between the second control switch and the inductor such that a current flows from the inductor to the second control switch.

13. The driving apparatus of claim 10, wherein the inductor resonates during the charge/discharge operation of the panel capacitor.

14. The driving apparatus of claim 10, wherein the charge power supply unit comprises two or more impedance elements serially connected between a power source and a ground terminal, and supplies a voltage to the energy storage unit by a voltage division operation of the impedance elements.

15. The driving apparatus of claim 14, wherein the charge power supply unit applies a voltage corresponding to ½ of the sustain voltage to the energy storage unit.

16. The driving apparatus of claim 14, wherein the impedance elements are resistors.

17. The driving apparatus of claim 14, wherein the impedance elements are capacitors.

18. An energy recovery circuit for a display panel to supply and recover energy from a panel capacitor, comprising:
a bidirectional switch connected to the panel capacitor to direct flow of charge to and from the panel capacitor;
a storage unit connected to the bidirectional switch to supply and to store the charge to/from the panel capacitor; and
a voltage supply connected to the storage unit and the bidirectional switch to supply voltage to the storage unit or the panel capacitor.

19. The energy recovery circuit of claim 18, wherein the voltage is ½ of a sustain discharge voltage.

20. The energy recovery circuit of claim 18, wherein the voltage supply comprises an inductive element.
